(19) United States
(12) Patent Application Publication
(10) Pub. No.: US 2015/0114743 A1
(43) Pub. Date: Apr. 30, 2015

(54) MOTORCYCLE WITH LATERAL SHOCK-ABSORBING DEVICE

(71) Applicant: DUCATI MOTOR HOLDING S.p.A., Bologna (IT)

(72) Inventor: Claudio DOMENICALI, Bologna (IT)

(21) Appl. No.: 14/519,446

(22) Filed: Oct. 21, 2014

(30) Foreign Application Priority Data
Oct. 24, 2013 (IT) MI2013A001775

(51) Int. Cl. B60B 27/00; B62K 11/02

(52) U.S. Cl. CPC B60B 27/0047; B62K 11/02; B60B 27/0052; B60Y 2200/12; B60B 2900/131
USPC 180/219

(57) ABSTRACT

A motorcycle including a frame with a median plane, one front wheel and one rear wheel, each wheel including a hub with its own longitudinal spindle onto which is fitted a rim carrying a tyre, the hub associated with a fork and at least one brake disc, the rim integral with a cylindrical portion fitted onto the hub. The hub having at one of its first lateral ends a protruding collar a distance from a corresponding first end of said the cylindrical portion, the second end of the hub cooperating with a flange also having a collar located at a distance from a second end of the cylindrical portion. Between the ends of the rim cylindrical portion and the above-mentioned hub collars and the flange are annular or cylindrical elastically deformable elements capable of absorbing stresses directed in lateral directions relative to the frame median plane.

This invention relates to a motorcycle according to the introductory part of the main claim.

As is known, a motorcycle comprises a frame mounted on wheels connected to said frame by means of front and rear forks, with two arms or a single arm. Shock-absorbing devices, capable of enabling the absorption of stresses that are generated along the median plane of the motorcycle, are associated with said forks.

During use, however, when the motorcycle negotiates a bend, it leans over to one side, at a very marked angle when the motorcycle is used in a competition. In this condition, the forks and shock-absorber devices associated with them are incapable of efficiently absorbing the stresses directed in lateral directions in relation to them, or rather, in relation to the median plane of the vehicle. These stresses, generated by the imperfections of the road surface, can contribute to the emergence of vibrations or “chattering” on the vehicle (particularly on its front part), which make it difficult to steer, especially at high speed.

In order to enable the absorption of the above-mentioned lateral stresses, various solutions are known that envisage shock-absorbing devices associated with at least the front wheel of the vehicle. These devices are very diverse but in general comprise an elastic or elastically deformable body connected to the hub of the wheel or to a part of the vehicle's steering assembly.

Known solutions do not enable a rapid adjustment of the shock-absorbing response of the above-mentioned device and are costly to produce and/or fit.

GB581845 describes a cycle or similar vehicle having a frame with a median plane, front and rear wheels, each of which comprises a hub having a longitudinal spindle on which is mounted a rim carrying a tyre. This hub is supported by a fork. Positioned between the hub and the rim is an elastically deformable cylindrical tubular device whose opposing ends form flanges interposed between said rim and protruding collars of the hub.

This known solution does not, however, enable adjustment of the shock-absorbing response of the shock-absorbing device defined by the cylindrical tubular device because, among other things, it is compressed between the rim and the single end collars as these form part of portions of the hub screwed tightly together.

The aim of the present invention is to offer a motorcycle provided with a shock-absorbing device capable of absorbing transverse stresses, or in any event stresses not arranged along the plane of the vehicle, that is an improvement on known solutions.

In particular, the aim of the invention is to offer a motorcycle in which said shock-absorbing device is simple to make and fit onto the vehicle in order to reduce the time taken for its possible replacement, which could be advantageous when this operation is performed on a competition motorcycle.

Another aim is to offer a motorcycle of the type described that allows the response of the shock-absorbing device to be easily and quickly calibrated.

These and other aims, which will become clear to a person skilled in the art, will be achieved by a motorcycle according to the accompanying claims.

A better understanding of this invention will emerge from the following drawings, given purely by way of a non-limiting example, in which:

FIG. 1 is a perspective view of a motorcycle wheel, without the tyre, but such as to embody the present invention;

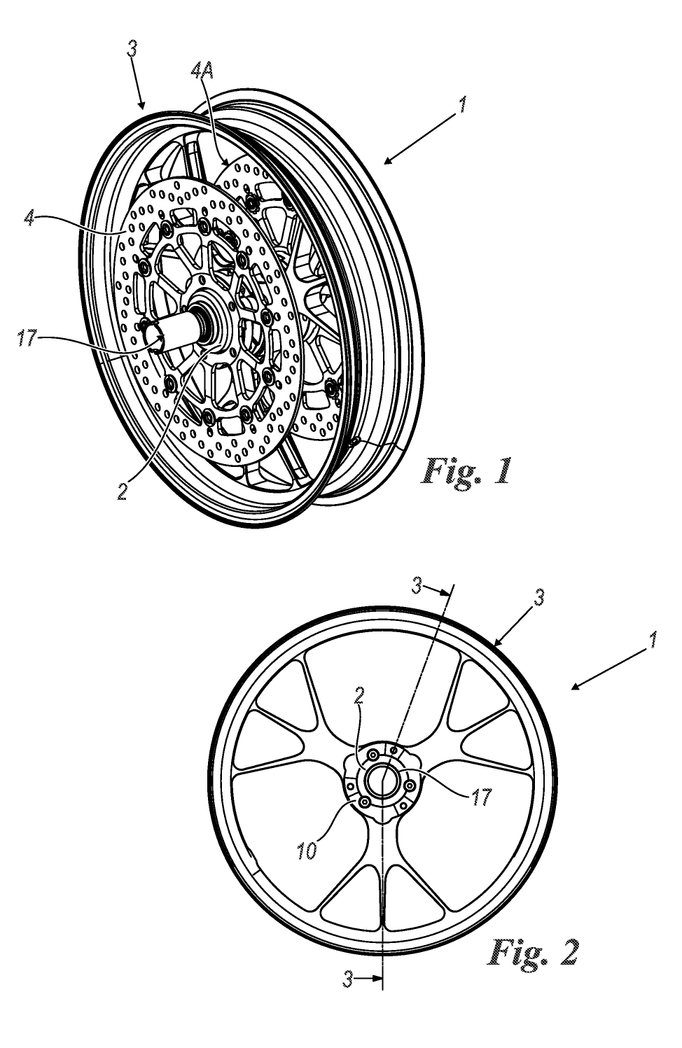

FIG. 2 is a front view of the wheel in FIG. 1 with some parts omitted for greater clarity;

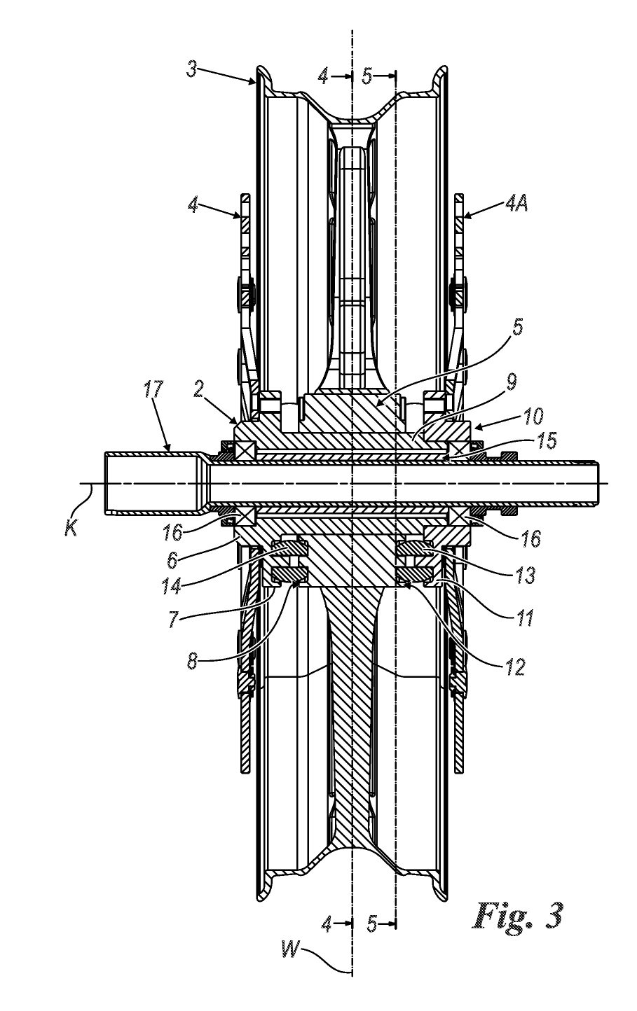

FIG. 3 is a cross-sectional view of the wheel in FIG. 1 along Line 3-3 of FIG. 2;

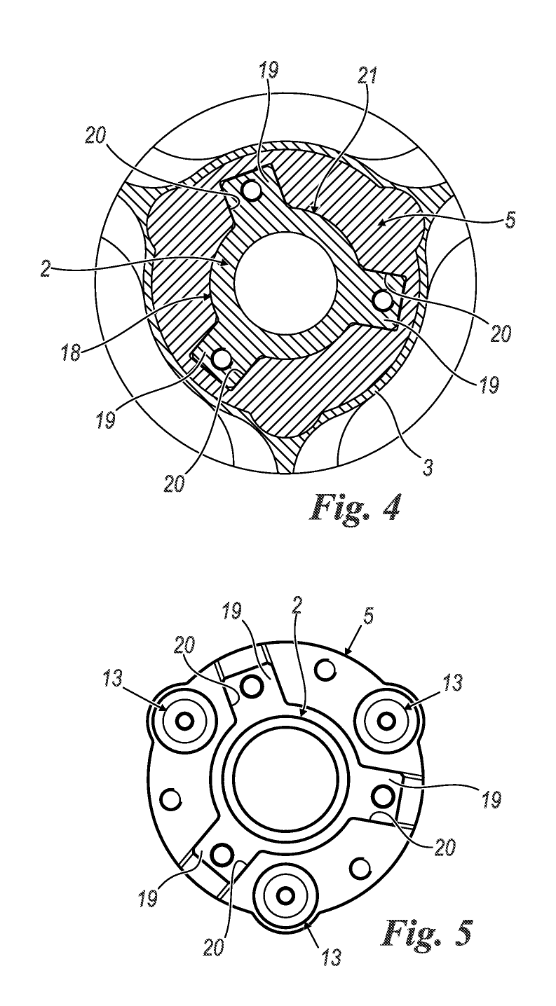

FIG. 4 is a view of a detail of a cross-section along Line 4-4 of FIG. 3;

FIG. 5 is a view of a detail of a cross-section along Line 5-5 of FIG. 3.

With reference to said figures, a wheel for a motorcycle is indicated generally by 1 and comprises a hub 2 having a first end 6, a second end 9 and a longitudinal spindle K. This hub 2 is fitted onto a hollow tubular spindle 15 carrying conventional bearings 16 at each opposing end that disconnect the hub from said spindle. The latter is connected in a known way, for example by means of a pin 17 inserted into said spindle 15, to a fork supporting the wheel (not shown), a fork that can be a double front fork or one large rear fork.

Near its first end 6, the hub 2 has a radially-protruding collar 7 onto which abuts a first brake disc 4 of a conventional motor vehicle braking system (comprising other known components, not shown). The second end 9 of the hub 2 is connected, by means of screws (not shown), to a wheel flange 10, which also has an (extremal) collar 11 resting on the above-mentioned second end 9. At the latter, a second brake disc 4A may be present.

On the hub 2 is located a floating rim 3 integral with a cylindrical portion 5 fitted onto the hub itself and torsionally secured to it. For this purpose, an external perimetral edge 18 of said hub 2 has a plurality of protrusions 19 inserted into recesses 20, of an equal number and conformation, provided on the internal surface of the cylindrical portion 5. The connection between said protrusions 19 and said recesses 20 creates the torsional bond between the rim 3 and the hub 2.

The cylindrical portion 5 has a first end 8 and a second end 12. The first end 8 faces, at a distance, towards the collar 7 of the hub 2; the second end 12 is by contrast located, at a distance, opposite the collar 11 of the flange 10. Between each end 8 and 12 and said collars 7 and 11, within corresponding seats of said components are located one or several pairs of annular shock-absorbing elements (as shown in the figures), cylindrical or of similar shapes 13 and 14, made of an elastically yielding material and capable of absorbing the lateral stresses supported by the wheel, that is, the stresses that do not lie along a median plane W of the latter mating with the median plane of the frame of the motorcycle (that is, of the latter).

The figures show a solution that provides three pairs of shock-absorbing elements 13, 14 arranged angularly equidistant from each other (in the example, at 120°) about the spindle K. This solution enables an optimum distribution of the absorption of the transverse lateral stresses that act on the wheel during the movement of the vehicle when the motorcycle leans over on a bend.

Clearly, the number of these pairs of elements 13, 14 is not limited to three (as in the figures), but can range from one to a number more than three.

Each pair of shock-absorbing elements 13, 14 (each defining a lateral shock-absorbing device of the wheel) can be made of rubber, a metal or polymer material, a material with a honeycomb structure or another anistropic or in any event shock-absorbing material.

Furthermore, the shock-absorbing response of the device defined by the shock-absorbing elements 13 can be modified by changing the transverse thickness of these devices, their shape, their total number or, as stated, the material from which they are made.

The replacement of elements 13 and 14 is facilitated by the presence of the wheel flange 10: this is screwed onto the hub and so, by removing the screws, the flange 10 can be separated from the hub 2 and removed. It is thus possible to remove the corresponding elements 13 at the end 12, pull off the rim and remove the corresponding elements 14 at the end 8. Having replaced these elements, the reverse procedure is followed, inserting the elements 13 and fixing the flange 10 to the hub 2 by means of screws.

Clearly, the collar 7 can form part of a component separate from the hub, but which is fixed to it like the flange 10 so as to hold between it and the portion 5 the shock-absorbing elements 14.

Thanks to the presence of the shock-absorbing elements 13 and 14, it is possible to absorb the transverse lateral stresses that act on the wheel and thus on the frame of the vehicle when the motorcycle leans over on negotiating a bend. In this case, any irregularity in the road surface is transferred to the wheel or rather to its tyre and thus to the rim 3. Thanks to the presence of the shock-absorbing elements 13 and 14, these stresses are not transferred (or at least are transferred in a contained manner) to the forks and thus to the vehicle's frame, avoiding or in any event containing and limiting the phenomenon of “chattering” felt by the rider. All this makes for better drivability of the vehicle by the rider and greater safety of the latter.

In other words, the invention enables a reduction in the occurrence of chattering, an improvement in the motorcycle's road-holding and therefore in its performance, guaranteeing less variation in the forces of contact with the ground.

In addition, elements 13 and 14 are still bodies that are easy to fit onto the hub 2 of the wheel 1 and easy to remove from it in order to modify the response of the shock-absorbing device defined by these elements. By altering the shape, number, dimensions and materials of the elastic shock-absorbing elements 13 and 14, their response to stresses can easily be calibrated to suit the rider's driving style, the conditions of the track or road, the tyres fitted, etc.

In addition, the shock-absorbing device according to the invention can be fitted on any type of motorcycle, even those with a conventional frame, in order to enable at least the reduction of “chattering” while negotiating a bend (with the bike leaning over).

The invention enables the longitudinal rigidity of the motorcycle to be dissociated from its lateral rigidity. This is particularly advantageous in the light of their different characteristics. The former, in fact, must be high to react to the forces that occur during extreme braking, whereas the lateral rigidity must be limited so as to be better able to absorb the stresses from the ground when negotiating bends while leaning over at great angles, conditions in which conventional suspension systems are inefficient.

A particular embodiment of the invention has been described. Others are however possible in the light of the preceding description: for example, elements 13 and 14 can be connected to a rear wheel of a motorcycle. These solutions are therefore to be regarded as falling within the scope of the following claims.

1. A motorcycle comprising:
a frame having a median plane,
one front wheel and one rear wheel, each wheel comprising a hub with its own longitudinal spindle onto which is fitted a rim carrying a tyre, said hub being associated with a fork and at least one brake disc or similar device of a braking system of the vehicle,
said rim having a cylindrical portion fitted onto said hub, the hub having at one of its first lateral ends a protruding collar located at a distance from a corresponding first end of said cylindrical portion,
the second end of said hub cooperating with a flange also having a collar located at a distance from a second end of said cylindrical portion,
there being between said ends of the cylindrical portion of the rim and the above-mentioned collars of the hub and of the flange elastically deformable elements capable of absorbing stresses directed in lateral directions in relation to the median plane of the frame,
wherein said elastically deformable elements comprise at least one pair of shock-absorbing elements located between the cylindrical portion of the rim and said collars of the hub and the flange.

2. The motorcycle according to claim 1, comprising three pairs of said elastically deformable elements arranged angularly equidistant from each other about a said longitudinal spindle of the hub.

3. The motorcycle according to claim 1, wherein the elastically deformable elements have the same mechanical and/or dimensional characteristics.

4. The motorcycle according to claim 1, wherein the elastically deformable elements have a shape chosen between an annular or cylindrical shape.

5. The motorcycle according to claim 1, wherein the collar at the first end of the hub forms one piece with the hub.

6. The motorcycle according to claim 1, wherein the collar at the first end of the hub is part of a component different from the hub, but fixed thereto.

7. The motorcycle according to claim 1, wherein each elastically deformable element is alternatively obtained from rubber, metal or polymer material, material with a honeycomb structure or anisotropic shock-absorbing material.

8. The motorcycle according to claim 3, wherein the elastically deformable elements have the same mechanical and dimensional characteristics.

8. The motorcycle according to claim 4, wherein the elastically deformable elements have an annular shape.

9. The motorcycle according to claim 4, wherein the elastically deformable elements have a cylindrical shape.

10. The motorcycle according to claim 7, wherein each elastically deformable element is alternatively obtained from rubber, metal or polymer material.

11. The motorcycle according to claim 7, wherein each elastically deformable element is obtained from material with a honeycomb structure rubber.

12. The motorcycle according to claim 7, wherein each elastically deformable element is obtained from anisotropic shock-absorbing material.
